(19) United States
(12) Patent Application Publication
(10) Pub. No.: US 2026/0349997 A1
(43) Pub. Date: Nov. 5, 2026

(54) GENERATIVE MODEL SYSTEM WITH AI CONTEXT PROTOCOL ENDPOINT-ENABLED SERVICE DISCOVERY AND REGISTRATION

(71) Applicant: Microsoft Technology Licensing, LLC, Redmond, WA (US)

(72) Inventors: Marc A. GOODNER, Kirkland, WA (US); Brian Scott KRABACH, Snohomish, WA (US)

(73) Assignee: Microsoft Technology Licensing, LLC, Redmond, WA (US)

(21) Appl. No.: 19/195,321

(22) Filed: Apr. 30, 2025

(51) Int. Cl. G06F 16/242

(52) U.S. Cl. CPC G06F 16/243

(57) ABSTRACT

A generative model system is provided with artificial intelligence (AI) context protocol endpoint-enabled service discovery, registration, and task management. The system includes a generative model agent configured to query an Artificial Intelligence Context Protocol (AICP) endpoint registry to identify applications at AICP endpoint servers, establish AI context protocol sessions with the endpoint servers, transmit contexts for the context protocol sessions to the applications hosted at the endpoint servers, and receive endpoint responses from each of the applications via the protocol sessions. The generative model agent then generates a query response based on the endpoint responses, and outputs the query response to an interaction interface.

### BACKGROUND

The advent of generative models, especially large language models, has significantly advanced human-computer interactions. These models are trained on extensive data sets that enable them to generate text which can be coherent and contextually relevant. At inference time, their pretraining enables these models to produce human-like text that answers user queries in a logical manner, sometimes with citations to grounded (i.e., trusted) sources of data. Users often interact with these generative models through various platforms, for example by inputting inquiries, asking questions, or seeking advice on a wide range of topics. Such interactions can span simple queries like asking for a weather forecast to complex discussions about philosophy, technology, and beyond.

However, a challenge that persists in the realm of such generative models is that they are limited in their ability to handle specialized tasks and retrieve specialized information. While large language models excel at producing text that is coherent and contextually relevant to a conversation history with the model and potentially to grounding sources, they often struggle to perform tasks that require specialized domain-specific expertise or actions. For example, ordering a pizza or managing a flight reservation involves a series of steps that need to be accurately and efficiently executed. These steps may include selecting specific items from a menu, specifying preferences, confirming availability, and completing payment processes. Similarly, retrieving specialized information in areas such as law, medicine, or engineering often necessitates a depth of knowledge and understanding that general-purpose generative models may lack. Even models trained on grounded sources of data may not properly apply the facts in those grounded sources. When a model encounters a query that it cannot properly handle, often it will (1) refrain from outputting any result, (2) output a statement that it cannot handle the query, or (3) output an incorrect response, i.e., a model hallucination. Each of these potential responses can leave the user dissatisfied and the query unaddressed.

As a result, currently users looking to perform such specialized tasks often resort to switching between multiple platforms, applications, or services, each designed to handle a specific type of task or provide information on a particular topic. This process can be cumbersome and inefficient, requiring users to adapt to different interfaces and interaction paradigms for each service they engage with. Moreover, these platforms are often siloed, operating independently of each other, which makes it difficult to perform tasks that may require the orchestration of multiple services or the retrieval of information from disparate sources.

### SUMMARY

To address the above issues, a computing system with artificial intelligence (AI) context protocol endpoint-enabled service discovery, registration, and task management is provided. According to one aspect, the computing system includes processing circuitry and associated memory configured to implement a generative model system including an interaction interface and a generative model agent. The interaction interface is configured to receive an input query including natural language. The generative model agent is configured to query an Artificial Intelligence Context Protocol (AICP) endpoint registry to identify at least a locally hosted application at a local AICP endpoint server and a remotely hosted application at a remote AICP endpoint server. At least one of the locally hosted application and remotely hosted application is a generative model. The generative model agent establishes a first artificial intelligence (AI) context protocol session with the local AICP endpoint server, transmits a first context for the first AI context protocol session to the locally hosted application at the local AICP endpoint server, via the first AI context protocol session, and receives a local endpoint response from the locally hosted application, via the first AI context protocol session. The generative model agent establishes a second AI context protocol session with the remote AICP endpoint server, transmits a second context for the second AI context protocol session to the remotely hosted application at the remote AICP endpoint server, via the second AI context protocol session, and receives a remote endpoint response from the remotely hosted application, via the second AI context protocol session. The generative model agent generates a query response based on the local endpoint response and the remote endpoint response, and outputs the query response to the interaction interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view showing a computing system according to a first example implementation, which uses a trained generative language model to generate a response to a message.

FIG. 2 is a schematic view showing a computing system according to a second example implementation, which uses a trained generative language model to generate a response to a message.

FIG. 3 is a schematic view showing a computing system according to a third example implementation, which also uses a trained generative language model to generate a response to a message.

FIG. 4 is a schematic view showing an example use scenario of the computing system of FIGS. 1-3.

FIG. 5 shows a flowchart of a first method for managing specialized tasks and information retrieval processes through service discovery according to one example implementation.

FIG. 6 shows a flowchart of a second method for managing specialized tasks and information retrieval processes through service discovery according to one example implementation.

FIG. 7 shows a schematic view of an example computing environment in which the computing system of FIGS. 1-4 may be enacted.

### DETAILED DESCRIPTION

Recently, an artificial intelligence (AI) context protocol has been proposed to enable models to interact with data sources that contain specialized knowledge or are equipped to perform specialized actions. The AI context protocol defines a schema for sending a current model context from a model to a data source, using a client-server model with a server endpoint provided at the data source and a client being instantiated at the model. One drawback associated with such current AI context protocols is that they require capabilities of endpoint data sources to be specified and registered ahead of time with the model using a configuration file that needs to be coded by a developer. This requires time and effort of developers, and can be difficult to implement at scale. Another drawback with current AI context protocols is that they require preregistration of the network location of each data source with each model. Thus, as new data sources become accessible at new network locations online, a model may be left unaware of the existence of new data sources if the new data sources have not been preregistered with the model by a developer. As data sources profilerate, this problem will become exacerbated.

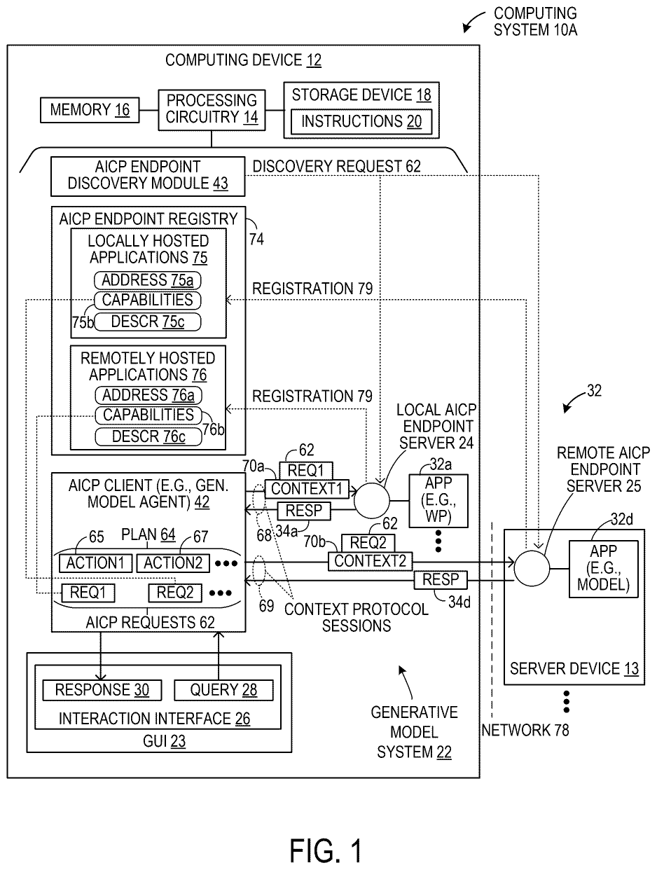

To address the various issues described above, FIG. 1 illustrates a schematic view of a computing system 10A for AI context protocol (AICP) enabled service registration and discovery, according to a first example implementation. The computing system 10A includes a computing device 12 having processing circuitry 14, memory 16, and a storage device 18 storing instructions 20 that enable the processing circuitry to perform the functions described herein. In this first example implementation, the computing system 10A takes the form of a single computing device 12 storing instructions 20 in the storage device 18, including a generative model program 22 that is executable by the processing circuitry 14 to perform various functions including causing an interaction interface 26 for an AICP client 42 to be presented, receiving, via the interaction interface 26, a query 28 from the user, and generating a response 30 to the user query 28. The interaction interface 26 may be a portion of a graphical user interface (GUI) 23 for accepting user input and presenting information to a user. The AICP client 42 may be configured as an orchestrator 42, for example. While illustrated as a single computing device 12 in FIG. 1, it will be understood that computing device 12 can be a distributed computing device 12 and the processing circuitry 14, memory 16, and storage device 18 of this implementation may be distributed among a plurality of physical devices connected by a computer network, with coordinated operations being performed among these devices in a distributed computing environment. For example, in a virtualized environment, storage, processing, and memory can be on different physical machines. As another example, computing device 12 may utilize client software that interacts with cloud services, and thus one or more functions described herein may be executed on a remote server.

An AICP is an application layer protocol in the open services interconnection (OSI) model of client server communications that facilitates interaction between AI models, as clients, and external services, as servers. An AICP endpoint refers to a server program operating at a network address that is configured with an application programming interface (API) for the external service, which operates according to the AICP protocol. The external service is thus a hosted application at the endpoint. The service is external to the model or model agent, but may be hosted locally on the same computing device or remotely on a server, for example.

One example AICP is the Model Context Protocol (MCP), which standardizes how AI models interact with external data sources, tools, and services, which are also characterized as AICP endpoints (or, MCP endpoints). AICP protocols such as MCP aim to provide a framework for the exchange of a model context with other application services, thereby enhancing the functionality of the model.

Continuing with FIG. 1, an AICP endpoint discovery module 43 is configured to interrogate a local AICP endpoint server 24 and a remote AICP endpoint server 25 to thereby obtain the respective IP addresses 75a, 76a, capabilities 75b, 76b, and text descriptions 75c, 76c of each of a locally hosted application 32a and a remotely hosted application 32d. The AICP endpoint discovery module 43 broadcasts a discovery call 62 to a plurality of applications 32, which include locally hosted applications 32a and remotely hosted applications 32d hosted on remote servers 13 within a network 78. In response, each application 32 returns registration information 79 which is stored in an AICP endpoint registry 74, which includes locally hosted applications 75 and remotely hosted applications 76. The registry 74 for locally hosted applications includes respective IP addresses 75a, functional capabilities 75b, and text descriptions 75c of each registered locally hosted application 75. Likewise, the registry 74 for remotely hosted applications 76 includes respective IP addresses 76a, functional capabilities 76b, and text descriptions 76c of each registered remotely hosted application 76. The functional capabilities are organized according to a predefined schema for such capabilities, including capability name and textual description. Locally hosted applications 75 are not particularly limited, and may include one or more of a word processor, spreadsheet program, presentation program, email program, database program, coding editor, and/or drawing program, for example. These are all hosted on the same physical computing device running the same operating system. Remotely hosted applications 76 are not particularly limited, and may include one or more of a generative language model, generative multimodal model, text-to-image generative model, for example. These are hosted on remote servers running a different operating system, or possibly on other virtual machines or containers on the same physical computing device in a virtualized or container environment.

The interaction interface 26 is configured to receive an input query 28 including natural language. The AICP client 42, configured as a generative model agent, receives the query 28 from the interaction interface 26. The AICP client 42 has been pretrained to perform internal reasoning prior to generating a response 30 to the query 28. Responsive to receiving the user query 28, the AICP client 42 formulates a plan 64 including at least a first action 65 and a second action 67 to respond to the query 28.

To formulate the plan 64, the AICP client 42 performs a lookup in the AICP endpoint registry 74 to identify a locally hosted application 32a at a local AICP endpoint server 24 that can perform a first task related to the first action 65 and a remotely hosted application 32d at a remote AICP endpoint server 25 that can perform a second task related to the second action 67.

The AICP client 42 queries the AICP endpoint registry 74 to identify at least the locally hosted application 32a at the local AICP endpoint server 24 and the remotely hosted application 32d at the remote AICP endpoint server 25. At least one of the locally hosted application 32a and the remotely hosted application 32d is a generative model.

Responsive to identifying at least the locally hosted application 32a and the remotely hosted application 32d, the AICP client 42 establishes a first AI context protocol session 68 with the local AICP endpoint server 24, and transmits a first context 70a for the first AI context protocol session 68 to the locally hosted application 32a at the local AICP endpoint server 24, via the first AI context protocol session 68. The AICP client 42 subsequently receives a local endpoint response 34a from the locally hosted application 32a, via the first AI context protocol session 68.

The AICP client 42 further establishes a second AI context protocol session 69 with the remote AICP endpoint server 25. The AICP client 42 then transmits the second context 70b for the second AI context protocol session 69 to the remotely hosted application 32d at the remote AICP endpoint server 25, via the second AI context protocol session 69. The AICP client 42 subsequently receives a remote endpoint response 34d from the remotely hosted application 32d, via the second AI context protocol session 69.

Responsive to receiving the local endpoint response 34a and the remote endpoint response 34d, the AICP client 42 generates a query response 30 based on the local endpoint response 34a and the remote endpoint response 34d, and outputs the query response 30 to the interaction interface 26. In some cases the generation of the query response 30 can be achieved by sending both to the local endpoint response 34a and the remote endpoint response 34d along with the query and associated context to a generative language model to thereby generate a response to the query. In another example the local endpoint response 34a and remote endpoint response 34d may be combined together, such as by insertion, concatenation, etc. and displayed via the interaction interface 26.

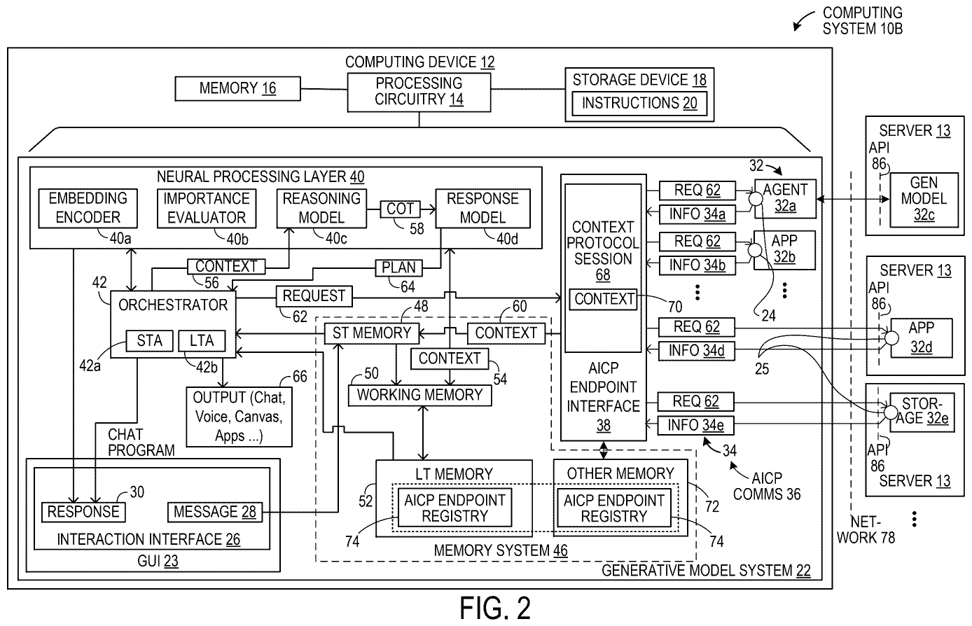

FIG. 2 illustrates a schematic view of a computing system 10B for managing specialized tasks and information retrieval processes, according to a second example implementation. Similarly to computing system 10A, the computing system 10B also includes a computing device 12 having processing circuitry 14, memory 16, and a storage device 18 storing instructions 20. In this second example implementation, the computing system 10B takes the form of a single computing device 12 storing instructions 20 in the storage device 18, including a generative model program 22 that is executable by the processing circuitry 14 to perform various functions including executing a plurality of agents 32, causing an interaction interface 26 for a trained generative models 40a-d of a neural processing layer 40 to be presented, and receiving, via the interaction interface 26, a message 28 from the user.

The neural processing layer 40 includes an embedding encoder 40a, an importance evaluator 40b, a reasoning model 40c, and a response model 40d. It will be understood that the trained generative models 40a-d encompass a broad range of generative models, including multi-modal models, diffusion models, and generative adversarial networks, which may receive text, image, and/or audio inputs and generate text, image, and/or audio outputs, as discussed in further detail below.

Each of the trained generative models 40a-d is a generative model that has been configured through machine learning to receive input that includes natural language text and generate output that includes natural language text in response to the input. It will be appreciated that the trained generative model 40a-d can be a large language model (LLM) having tens of millions to billions of parameters, non-limiting examples of which include GPT-3, BLOOM, and LLaMa-2. The trained generative language model 40a-d can be a multi-modal generative model configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output. Non-limiting examples of multi-modal generative models include Kosmos-2 and GPT-4 VISUAL. Further, the trained generative language model 40a-d can be configured to have a generative pre-trained transformer architecture, examples of which are used in the GPT-3 and GPT-4 models.

The generative model program 22 also includes an orchestrator 42 identifies one or more agent tasks based on the message 28. To discover available services, the orchestrator 42 sends a request 62 to an AICP endpoint interface 38 to broadcast the request 62 to a plurality of agents 32. In response, each agent 32a-e returns respective service information 34a-e to the AICP endpoint interface 38 in accordance with AICP. The AICP endpoint interface 38 forwards the service information 34a-e as contextual information 60 to the short-term memory 48 of the memory system 46. The contextual information 60 is appended to the short-term memory 48 by the memory system 46 and forwarded to the orchestrator 42. The orchestrator generates output 66 in accordance with the contextual information 60. The output 66 of the orchestrator 42 is not particularly limited, and may encompass one or more modalities. For example, the output 66 may include making calls to cause one or more agents 32 to execute one or more tasks, and/or outputting a response 30 on a voice interface, chat interface, and/or a canvas, for example. The output 66 is configured in accordance with AICP so that the orchestrator 42 may easily interface with agents 32 that have also implemented AICP.

In some instances, the interaction interface 26 may be a portion of a GUI 23 for accepting user input and presenting information to a user. In other instances, the interaction interface 26 may be presented in non-visual formats such as an audio interface for receiving and/or outputting audio, such as may be used with a digital assistant. In yet another example the interaction interface 26 may be implemented as an interaction interface application programming interface (API). In such a configuration, the input to the interaction interface 26 may be made by an API call from a calling software program to the interaction interface API, and output may be returned in an API response from the interaction interface API to the calling software program. The API may be a local API or a remote API accessible via a computer network such as the Internet. It will be understood that distributed processing strategies may be implemented to execute the software described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. Thus, the processing circuitry 14 may be configured to execute the interaction interface API (for example, interaction interface 26) for the trained generative models 40a-d, so that the processing circuitry 14 is configured to interface with the trained generative models 40a-d that receives input of contextual information 54 and, in response, generates a response 30 that includes natural language text output. Likewise, communications between the orchestrator 42 and agents 32 and the trained generative models 40a-d can be implemented using local or remote APIs.

In general, the processing circuitry 14 may be configured to receive, via the interaction interface 26 (in some implementations, the interaction interface API), the message 28 as natural language text input. The memory system 46 subsequently appends the message 28 to short-term memory 48, which may hold immediate recent interactions between the user and the generative model program 22. For example, the short-term memory 48 may hold a predetermined number of messages (10 messages, for example). The short-term memory provides context for current and recent exchanges between the user and the generative model program 22, and aids in resolving references and understanding user intent.

The memory system 46 concatenates or aggregates the short-term memory 48 into working memory 50, encodes the working memory 50 into embeddings via the embedding encoder 40a. The working memory 50 acts as an intermediary, synthesizing information from the short-term memory 48 to form a cohesive context. Through the exchange of contextual information 54, the memory system 46 queries the importance evaluator 40b of the neural processing layer 40 to assign an importance score to the encoded working memory 50. When the importance score returned by the importance evaluator 40b exceeds a predetermined score threshold, then the memory system 46 appends the working memory 50 to the long-term memory 52.

The long-term memory 52 may store significant information, insights, and important tasks over extended periods, providing historical context for interactions, supporting advanced querying, and implementing mechanisms to reduce hallucinations by grounding information in actual user interactions. The operations of the memory system 46 may be performed continuously in real-time, so that the memory system 46 continuously incorporates new data into short-term memory 48, aggregates the short-term memory 48 into working memory 50, and then stores the high importance working memory 50 into the long-term memory 52.

To manage specialized tasks and information retrieval processes, an interaction interface 26 is provided by which a message 28 can be received as user input. The message 28 is processed by the memory system 46, which appends the message 28 to the existing short-term memory 48. The appended short-term memory 48 is then appended to the working memory 50, which is encoded into embeddings by the embedding encoder 40a.

The orchestrator 42 may receive the short-term memory 48 with the appended message 28 and parse the message 28 to generate an agent request 62. Using the neural processing layer 40, the orchestrator 42 may identify short-term actions 42a and/or long-term actions 42b based on the message 28, and incorporate these short-term actions 42a and/or long-term actions 42b in the agent request 62 to be broadcast to the agents 32. The agent request 62 may be formatted and sent in accordance with AICP.

Short-term actions 42a are immediate tasks requiring prompt execution, often based on recent interactions. Examples of short-term actions 42a include sending an e-mail or scheduling a meeting. Long-term actions 42b are tasks that are part of ongoing projects or require extended time to complete. Examples of long-term actions 42b include developing a marketing strategy or compiling a comprehensive report. The orchestrator 42 may cause one or more agents 32a to execute the short-term actions 42a and/or long-term actions 42b. The agents 32a which execute the long-term actions 42b may be human agents for tasks requiring human judgment or expertise, or AI agents for tasks suitable for automation, including data analysis, for example.

The orchestrator 42 may generate and send a request 62 to one or more agents 32 by using an AICP endpoint interface 38 to broadcast the request 62 to the agents 32. The agents 32a-e then reply with respective service information 34a-e which may indicate supported input/output modalities, functional capabilities, internal tools, performance metrics, and credentialing and access requirements of each agent 32a-e, for example. As illustrated in FIG. 2, some of the agents 32 may be applications, such as locally hosted application 32b, remotely hosted application 32d, and remotely hosted storage application 32e. A locally hosted agent 32a may interface with a remotely hosted application 32c, such as a generative model 32c.

The request 62 and service information 34 may be characterized as AICP communications 36 exchanged between AICP endpoint servers 24, 25. The agents 32a-3 may be hosted internally within the computing system 10B, or externally outside of the computing system 10B as remote agents. In this example, agents 32a and 32b are coupled to AICP endpoint servers 24 that are hosted within the computing system 10B, while agents 32d and 32e are coupled to AICP endpoint servers 25 remotely hosted outside the computing system 10B. Remote agent 32d, 32e communicate with the AICP endpoint interface 38 within a network 78 via an API 86.

To communicate with locally hosted agent 32a, 32b, the AICP endpoint interface 38 may establish a context protocol session 68 to transmit a context 70 for the context protocol session 68 to the locally hosted agent 32a, 32b at the local AICP endpoint server 24. To communicate with each remotely hosted agent 32d, 32e, the AICP endpoint interface 38 may a establish a context protocol session 68 to transmit a context 70 for the context protocol session 68 to the remotely hosted agent 32d, 32e at the remote AICP endpoint server 25.

The AICP endpoint interface 38 forwards the respective service information 34a-e as contextual information 60, which is appended to the short-term memory 48 and send to the orchestrator 42. The orchestrator 42 then causes a subset of the plurality of agents 32 to perform a task and/or retrieve information in specialized domains of the subset of the plurality of agents 32 in accordance with the contextual information 60. The appended service information 34 in the short-term memory 48 may be migrated to the working memory 50 and subsequently to the long-term memory 52 by the memory system 46, so that the service information 34 is stored in the long-term memory 52 as a registry of services (AICP endpoint registry 74) for subsequent retrieval by the orchestrator 42. Accordingly, the long-term memory 52 stores contextual information 60 about the agents 32 in an AICP endpoint registry 74. Additionally or alternatively, the AICP endpoint interface 38 may send the contextual information 60 for storage within an AICP endpoint registry 74 in other memory 72 within the memory system 46.

The memory system 46 appends the short-term memory 48 containing the contextual information 60 to the working memory 50, which is encoded into embeddings by the embedding encoder 40a and given an importance score by the importance evaluator 40b. When the importance score exceeds a predetermined score threshold, then the memory system 46 appends the working memory 50 containing the contextual information 60 to the long-term memory 52. Accordingly, the registry of services offered by the plurality of agents 32 is maintained in the long-term memory 52, which may be configured to track service usage history. Accordingly, the selection of the subset of agents 32 by the orchestrator 42 to execute the identified tasks 42a, 42b may be optimized, thereby ensuring that frequently accessed agents 32 are prioritized.

Once registered, the services of the agents 32 may be seamlessly integrated into task execution. The reasoning model 40c and the response model 40d may delegate work to the most appropriate agent 32 based on reliability, response time, relevance, efficiency, real-time conditions, and workload distribution. At the same time, underperforming services may be deprioritized. By dynamically adjusting the parameters of requests 62 and optimizing data exchanges between the agents 32 and the neural processing layer 40, optimal performance can be ensured.

The orchestrator 42 may encode the message 28 into embeddings using the embedding encoder 40a, and then retrieve parts of long-term memory 52 that are similar to the message 28 as relevant parts of the long-term memory 52. Similarity may be determined using a similarity metric or distance function. The orchestrator 42 may then compile the relevant parts of the long-term memory 52, the short-term memory 48, working memory 50, identified short-term actions 42a, and identified long-term actions 42b into a contextual bundle 56, and input the contextual bundle 56 into the reasoning model 40c to generate a chain-of-thought response 58. The contextual bundle 56 may be sent to the reasoning model 40c in accordance with AICP. The chain-of-thought response 58 may be inputted into the response model 40d to generate a plan 64 for using a subset of the plurality of agents 32 to execute the identified short-term actions 42a and/or long-term actions 42b. The response model 40d then sends the plan 64 to the orchestrator 42 in accordance with AICP. The orchestrator 42 may then make API calls to the subset of the plurality of agents 32 to execute the identified short-term actions 42a and/or long-term actions 42b in accordance with the plan 64 generated by the response model 40d. The execution of the short-term actions 42a and/or long-term actions 42b is illustrated as output 66 in FIG. 2.

In response, the subset of the plurality of agents 32 may output natural language agent output 34a-e, which may be generated using a trained generative language model accessible by each of the plurality of agents 32. The orchestrator 42 may process the generative output from the one or more of the subset of agents 32 into a natural language response 30, and output the response 30 via the interaction interface 26.

The agents 32 may be instantiated as specialized software modules configured to handle specific domains of tasks or requests. The agents 32 may be generative modules configured with specialized algorithms or processing capabilities to execute specific tasks in various specialized domains, which may include but are not limited to finance, healthcare, artwork, game design, and food services. The agents 32 are configured to retrieve information and/or perform tasks that directly align with their areas of expertise.

The agents 32 may operate in either an autonomous or consensus-driven mode. In an autonomous mode, the agents 32 may work independently and uncoordinated with one another. In a consensus-driven mode, the agents 32 may collaborate and arrive at a decision based on collective intelligence.

The agent 32 may execute request handling logic to parse and process the context of a request from the orchestrator 42. The request from the orchestrator 42 may be formatted in accordance with AICP and encoded in JSON, XML, or any other suitable data-interchange format that encapsulates the user's intent, query parameters, and other context-relevant information. After retrieving relevant information from the subset of the plurality of agents 32, the orchestrator 42 may generate a response 30 containing the retrieved relevant information, and the response 30 displayed to the user via the interaction interface 26.

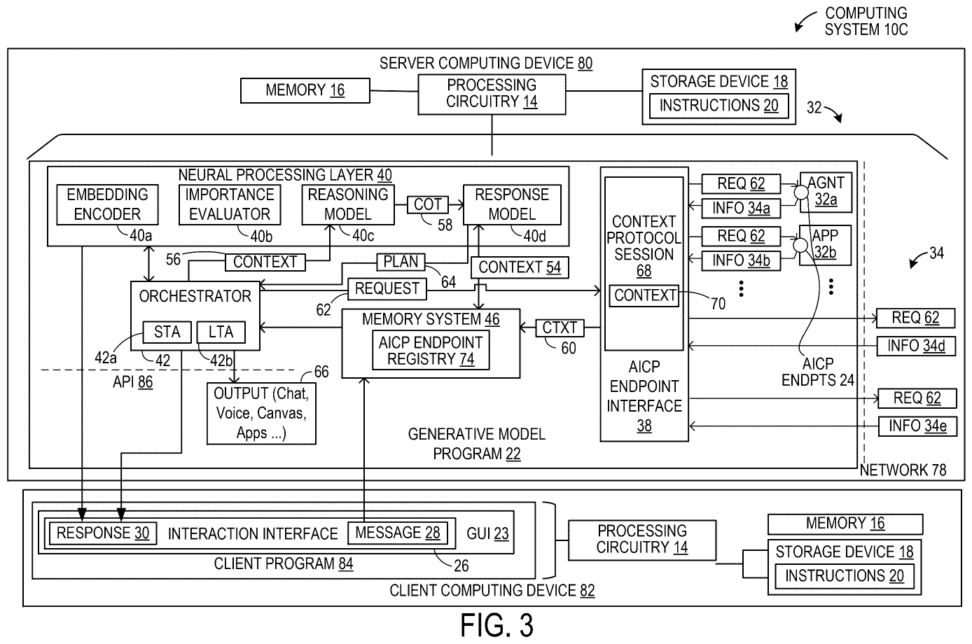

Turning to FIG. 3, a computing system 10C according to a third example implementation is illustrated, in which the computing system 10C includes a server computing device 80 and a client computing device 82. Here, both the server computing device 80 and the client computing device 82 may include respective processing circuitry 14, memory 16, and storage devices 18. Description of identical components to those in FIG. 2 will not be repeated. As shown in FIG. 3, the generative models 40a-d and the generative model program 22 can be executed on a different server 80 from the computing device 82 executing the interaction interface 26, and the client program 84 executed on the computing device 82 can send a request or message 28 to an API 86 of the generative model program 22 on the different server 80 across a computer network such as the Internet, and in turn receive a response, in some examples.

The client computing device 82 may be configured to present the interaction interface 26 as a result of executing a client program 84 by the processing circuitry 14 of the client computing device 82. The client computing device 82 may be responsible for communicating between the user operating the client computing device 82 and the server computing device 80 which executes the generative model program 22 and contains the orchestrator 42, respective agents 32, and the generative models 40a-d, via an API 86 of the generative model program 22. The client computing device 82 may take the form of a personal computer, laptop, tablet, smartphone, smart speaker, etc. The same processes described above with reference to FIG. 2 may be performed, except in this case the natural language text input 28 and output 30, 66 may be communicated between the server computing device 80 and the client computing device via a network such as the Internet.

Further, the generative models 40a-d may be executed on a different server from the server computing device 80 depicted in FIG. 3. In such an embodiment, the server computing device 80 may invoke an API call to transmit a data request to a different external server executing the generative models 40a-d. Upon receipt of the data request, the external server may decode the incoming API call and extract input parameters, receiving input of the prompt including natural language text input. The API of the generative model 40a-d, acting as a gateway, may channel the input of the prompt into the generative model 40a-d for processing. The generative model 40a-d, executed on the external server, may perform its operations and generate a response that includes natural text output. The response may be encapsulated by the API of the generative model 40a-d and transmitted back to the server computing device 80, which receives, in response to the prompt, the response from the trained generative models 40a-d, and output the response to the user.

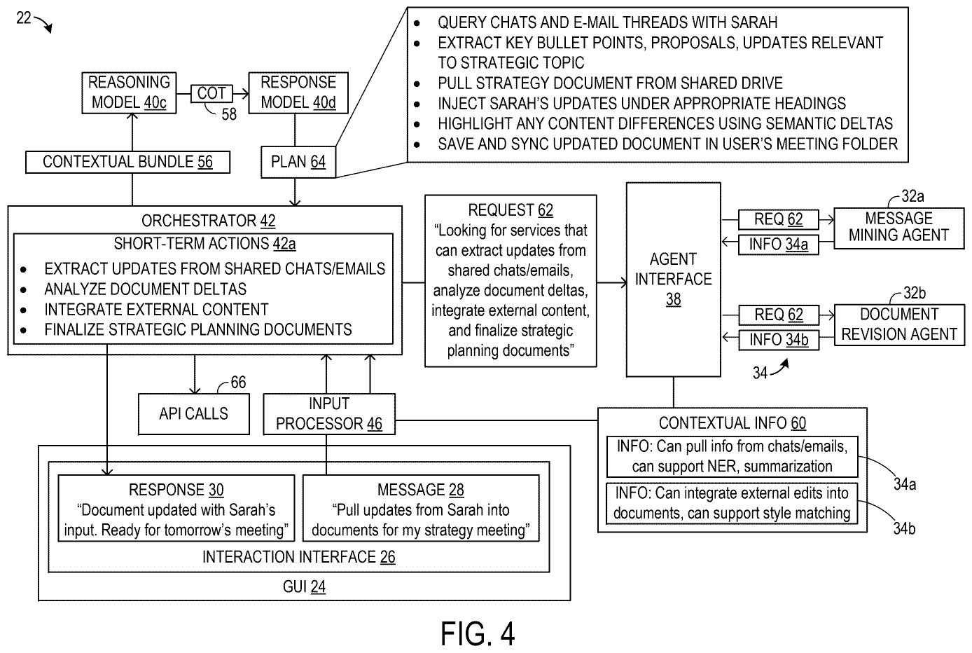

Turning now to FIG. 4, an example use of the generative model program of FIG. 2 is illustrated. In this example use scenario, a user uses the voice interaction interface 26 to input the message 28, “pull updates from Sarah into documents for my strategy meeting”. The voice interaction interface 26 captures the audio and performs real-time speech-to-text conversion. The message 28 is passed to the memory system 46, which appends the message 28 to short-term memory and then passes the short-term memory with the appended message 28 to the orchestrator 42.

The orchestrator 42 uses the reasoning model 40c and memory from the memory system 46 to parse the user's message 28. The orchestrator 42 identifies four short-term actions 42a which correspond to the message 28: extract updates from shared chats and e-mails, analyze document deltas, integrate the external content, and finalize strategic planning documents.

The orchestrator 42 incorporates the four identified short-term actions 42a into a request 62 to broadcast through the AICP endpoint interface 38 to the various agents 32: “Looking for services that can extract updates from shared chats/emails, analyze document deltas, integrate external content, and finalize strategic planning documents”.

Multiple agents 32a, 32b respond to the request 62. The message mining agent 32a responds with service information 34a indicating its functional capabilities: it can pull information from chats and e-mails, and it supports Named Entity Recognition and Summarization. The document revision agent 32b responds with service information 34b indicating its functional capabilities: it can integrate external edits into documents, and it supports style matching. The service information 34a, 34b about the functional capabilities of the agents 32a, 32b are incorporated into contextual information 60 and incorporated into the short-term memory 48 of the memory system 46. Parts of the service information 34a, 34b which are deemed important by the importance evaluator 40b are subsequently stored in the long-term memory 52.

The orchestrator 42 receives the short-term memory 48 containing the contextual information 60. The orchestrator 42 encodes the message 28 into embeddings, and then retrieves parts of the long-term memory 52 that is determined to be relevant or similar to the encoded message 28. The relevant parts of the long-term memory 52 may provide relevant context to the message 28, such as who Sarah is (colleague in marketing), the location of the strategy documents, the meeting time from the calendar, and the communication history between the user and Sarah.

The orchestrator 42 compiles the relevant long-term memory, the short-term memory 48, working memory 50, and the identified short-term actions 42a into a contextual bundle 56 to be inputted into the reasoning model 40c, which generates a chain-of-thought response 58. The response model 40d receives the chain-of-thought response 58 and generates a plan 64 which indicates a chain of operations.

In this example, the plan 64 involves the message mining agent 32a querying chats and e-mail threads with Sarah, extracting key bullet points, proposals, and updates relevant to the strategic topic, and pulling the strategy document from the shared drive. Then the plan 64 continues with the document revision agent 32b injecting Sarah's updates into the strategy document under appropriate headings, highlighting any content differences using semantic deltas, and saving and syncing the updated strategy document in the meeting folder of the user. The orchestrator 42 executes the plan 64 by making API calls 66 to the message mining agent 32a and the document revision agent 32b in accordance with AICP. When the execution of the plan 64 is completed, the orchestrator generates a response 30 as voice output indicating that the document has been “updated with Sarah's input”, and the document is “ready for tomorrow's meeting”.

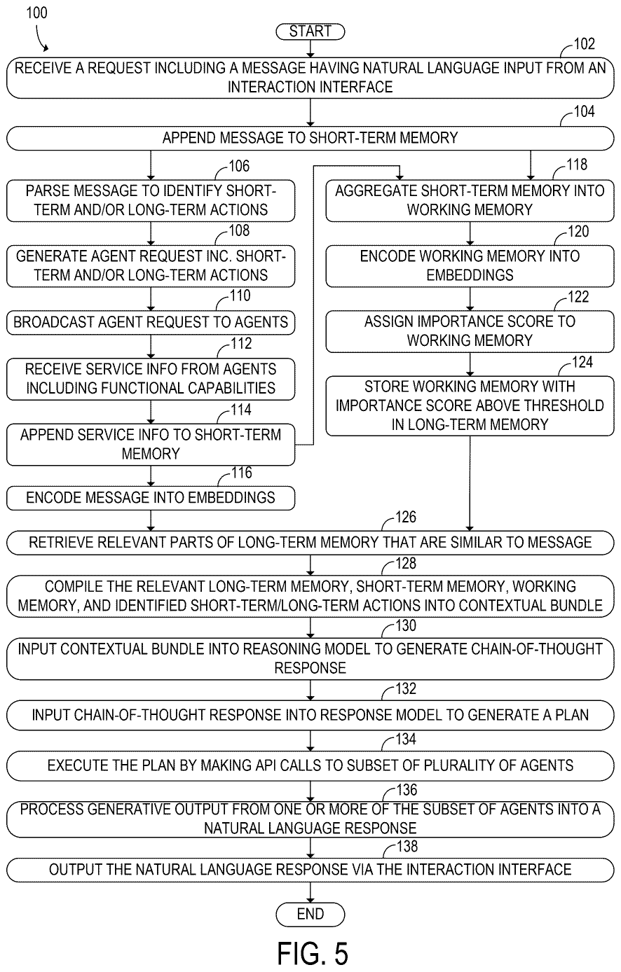

FIG. 5 is a flowchart that illustrates a first method 100 for managing specialized tasks and information retrieval processes. The first method 100 may be implemented on the computing system 10A, 10B, or 10C illustrated in FIGS. 1-4 above, which include processing circuitry and associated memory configured to implement an interaction interface, an orchestrator, an memory system, a neural processing layer, an AICP endpoint interface, and a plurality of response agents. Alternatively, other suitable computing hardware and software may be utilized.

At 102, the method includes receiving a request including a message having natural language input from the interaction interface. At 104, the method includes appending the message to short-term memory. At 106, the method includes parsing the message to identify short-term actions and/or long-term actions. At 108, the method includes generating an agent request including the short-term actions and/or the long-term actions. At 110, the method includes broadcasting the agent request to a plurality of agents. At 112, the method includes receiving service information including functional capabilities from the plurality of agents. At 114, the method includes appending the service information to the short-term memory.

Subsequent to the data becoming appended to the short-term memory at steps 104 and 114, the appended data migrates into working memory and long-term memory at steps 118, 120, 122, and 124, which are performed continuously in real-time. At 118, the method includes aggregating the short-term memory into working memory. At 120, the method includes encoding the working memory into embeddings. At 122, the method includes assigning an importance score to the working memory. At 124, it is determined whether the importance score assigned to the working memory is above a predetermined score threshold. Responsive to determining that the importance score is above the predetermined score threshold, at 124, the working memory is stored in long-term memory.

At 116, the method includes encoding the message into embeddings. At step 126, the method includes retrieving parts of long-term memory that are similar to the message as relevant long-term memory. Similarity may be determined using a similarity metric or distance function. At 128, the method includes compiling the relevant long-term memory, short-term memory, working memory, and identified short-term actions and/or identified long-term actions into a contextual bundle. At 130, the method includes inputting the contextual bundle into the reasoning model to generate a chain-of-thought response. At step 132, the method includes inputting the chain-of-thought response into a response model to generate a plan for using a subset of the plurality of agents to execute the identified short-term actions and/or long-term actions. At 134, the method includes making API calls to the subset of the plurality of agents to execute the identified short-term actions and/or long-term actions in accordance with the plan generated by the response model.

At 136, the method includes processing generative output from one or more of the subset of the plurality of agents into a natural language response. At 138, the method includes outputting the natural language response via the interaction interface.

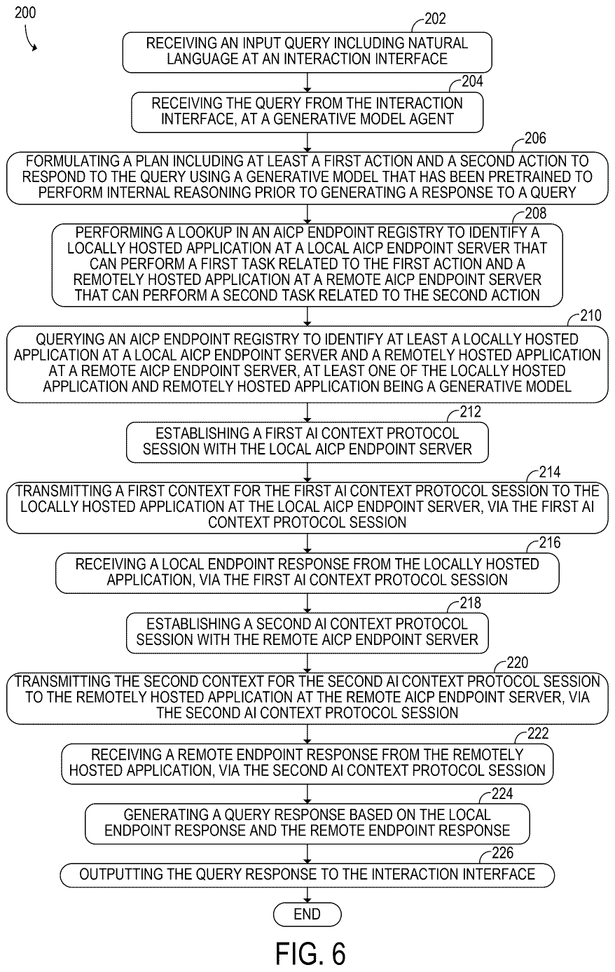

FIG. 6 is a flowchart that illustrates a second method 200 for managing specialized tasks and information retrieval processes. The second method 200 may be implemented on the computing system 10A, 10B, or 10C illustrated in FIGS. 1-4 above, which include processing circuitry and associated memory configured to implement an interaction interface, an orchestrator, an memory system, a neural processing layer, an AICP endpoint interface, and a plurality of response agents. Alternatively, other suitable computing hardware and software may be utilized.

At 202, the method includes receiving an input query including natural language at an interaction interface. At 204, the method includes receiving the query from the interaction interface, at a generative model agent.

At 206, the method includes formulating a plan including at least a first action and a second action to respond to the query using a generative model that has been pretrained to perform internal reasoning prior to generating a response to a query.

At 208, the method includes performing a lookup in an AICP endpoint registry to identify a locally hosted application at a local AICP endpoint server that can perform a first task related to the first action and a remotely hosted application at a remote AICP endpoint server that can perform a second task related to the second action.

At 210, the method includes querying an AICP endpoint registry to identify at least a locally hosted application at a local AICP endpoint server and a remotely hosted application at a remote AICP endpoint server, at least one of the locally hosted application and remotely hosted application being a generative model.

At 212, the method includes establishing a first AI context protocol session with the local AICP endpoint server. At 214, the method includes transmitting a first context for the first AI context protocol session to the locally hosted application at the local AICP endpoint server, via the first AI context protocol session.

At 216, the method includes receiving a local endpoint response from the locally hosted application, via the first AI context protocol session. At 218, the method includes establishing a second AI context protocol session with the remote AICP endpoint server.

At 220, the method includes transmitting the second context for the second AI context protocol session to the remotely hosted application at the remote AICP endpoint server, via the second AI context protocol session. At 222, the method includes receiving a remote endpoint response from the remotely hosted application, via the second AI context protocol session. At 224, the method includes generating a query response based on the local endpoint response and the remote endpoint response. At 226, the method includes outputting the query response to the interaction interface.

The above-described systems and methods may seamlessly manage a range of specialized tasks and information retrieval processes through a single interface by employing multiple agents, each with their own specialized area of expertise, and an orchestrator that broadcasts discovery calls to the agents and receives service information that include capability metadata and access requirements. By maintaining an evolving registry of agent services in long-term memory, the orchestrator may remain adaptable to new tools and applications. The neural processing layer further refines agent service recommendations by evaluating contextual factors, thereby improving the ability to anticipate user needs and streamlining the user experience in engaging with complex tasks and specialized information queries. Compared to traditional service discovery methods, this automated, context-aware approach actively seeks and incorporates services by integrating generative models. This may enhance service accessibility, minimize manual input, and optimize service utilization by dynamically suggesting appropriate agent service combinations for various user scenarios.

The above-described systems and methods may be applied across multiple domains. In enterprise workflows, they may be applied to discover and integrate document summarization tools, transcription services, or project management assistants without user intervention. In software development, they may be applied to dynamically register debugging tools, code analyzers, and deployment automation services based on project needs. For research, they may be applied to identify and integrate relevant data sources, analysis tools, and content summarization capabilities in real-time.

In some embodiments, the methods and processes described herein may be tied to a computing system of one or more computing devices. In particular, such methods and processes may be implemented as a computer-application program or service, an application-programming interface (API), a library, and/or other computer-program product.

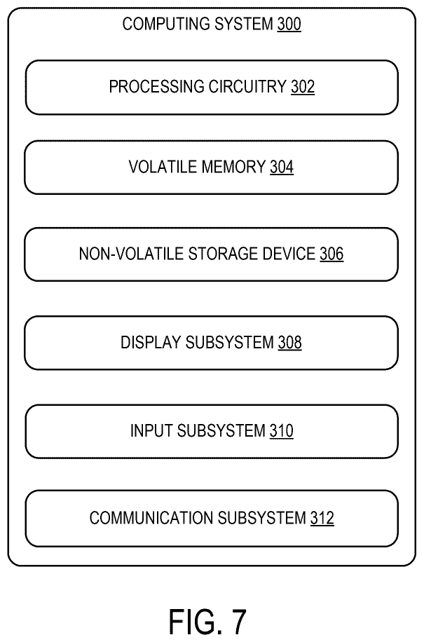

FIG. 7 schematically shows a non-limiting embodiment of a computing system 300 that can enact one or more of the methods and processes described above. Computing system 300 is shown in simplified form. Computing system 300 may embody the computing systems 10A, 10B, or 10C described above and illustrated in FIG. 1-3, respectively. Components of computing system 300 may be included in one or more personal computers, server computers, tablet computers, home-entertainment computers, network computing devices, video game devices, mobile computing devices, mobile communication devices (for example, smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 7.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included display subsystem 308 may be used to present a visual representation of data held by non-volatile storage device 306. The visual representation may take the form of a GUI. As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional support for the claims of the subject application. One aspect provides a computing system with artificial intelligence (AI) protocol endpoint-enabled service discovery, registration, and task management, the system comprising processing circuitry and associated memory configured to implement a generative model system including an interaction interface configured to receive an input query including natural language, and a generative model agent configured to query an Artificial Intelligence Context Protocol (AICP) endpoint registry to identify at least a locally hosted application at a local AICP endpoint server and a remotely hosted application at a remote AICP endpoint server, at least one of the locally hosted application and remotely hosted application being a generative model, establish a first AI context protocol session with the local AICP endpoint server, transmit a first context for the first AI context protocol session to the locally hosted application at the local AICP endpoint server, via the first AI context protocol session, receive a local endpoint response from the locally hosted application, via the first AI context protocol session, establish a second AI context protocol session with the remote AICP endpoint server, transmit a second context for the second AI context protocol session to the remotely hosted application at the remote AICP endpoint server, via the second AI context protocol session, receive a remote endpoint response from the remotely hosted application, via the second AI context protocol session, generate a query response based on the local endpoint response and the remote endpoint response, and output the query response to the interaction interface. In this aspect, additionally or alternatively, the AICP endpoint registry may include respective IP addresses, capabilities, and text descriptions of each of the locally hosted application and the remotely hosted application. In this aspect, additionally or alternatively, the system may further comprise an AICP endpoint discovery module configured to interrogate the local AICP endpoint server and the remote AICP endpoint server to thereby obtain the respective IP addresses, capabilities, and text descriptions of each of the locally hosted application and the remotely hosted application. In this aspect, additionally or alternatively, the generative model agent may be further configured to, prior to querying the AICP endpoint registry receive the input query from the interaction interface, formulate a plan including at least a first action and a second action to respond to the input query using the generative model that has been pretrained to perform internal reasoning prior to generating the query response to the input query, and perform a lookup in the AICP endpoint registry to identify the locally hosted application at the local AICP endpoint server that can perform a first task related to the first action and the remotely hosted application at the remote AICP endpoint server that can perform a second task related to the second action. In this aspect, additionally or alternatively, the local AICP endpoint server may be one of a plurality of local AICP endpoint servers, each having a respective locally hosted application. In this aspect, additionally or alternatively, the locally hosted applications may be one or more of a word processor, spreadsheet program, presentation program, email program, database program, coding editor, and/or drawing program. In this aspect, additionally or alternatively, the remote AICP endpoint server may be one of a plurality of remote AICP endpoint servers, each having a respective remotely hosted application. In this aspect, additionally or alternatively, the remotely hosted applications may be one or more of a generative language model, generative multimodal model, text-to-image generative model. In this aspect, additionally or alternatively, the memory may be configured to include short term memory, working memory, long term memory, and the AICP endpoint registry stored in the long term memory.

Another aspect provides a generative model computerized method with artificial intelligence (AI) protocol endpoint-enabled service discovery, registration, and task management, the method comprising receiving an input query including natural language at an interaction interface, querying an Artificial Intelligence Context Protocol (AICP) endpoint registry to identify at least a locally hosted application at a local AICP endpoint server and a remotely hosted application at a remote AICP endpoint server, at least one of the locally hosted application and remotely hosted application being a generative model, establishing a first AI context protocol session with the local AICP endpoint server, transmitting a first context for the first AI context protocol session to the locally hosted application at the local AICP endpoint server, via the first AI context protocol session, receiving a local endpoint response from the locally hosted application, via the first AI context protocol session, establishing a second AI context protocol session with the remote AICP endpoint server, transmitting a second context for the second AI context protocol session to the remotely hosted application at the remote AICP endpoint server, via the second AI context protocol session, receiving a remote endpoint response from the remotely hosted application, via the second AI context protocol session, generating a query response based on the local endpoint response and the remote endpoint response, and outputting the query response to the interaction interface. In this aspect, additionally or alternatively, the AICP endpoint registry may include respective IP addresses, capabilities, and text descriptions of each of the locally hosted application and the remotely hosted application. In this aspect, additionally or alternatively, the computerized method may further comprise interrogating the local AICP endpoint server and the remote AICP endpoint server to thereby obtain the respective IP addresses, capabilities, and text descriptions of each of the locally hosted application and the remotely hosted application. In this aspect, additionally or alternatively, the computerized method may further comprise, prior to querying the AICP endpoint registry, receiving the input query from the interaction interface, formulating a plan including at least a first action and a second action to respond to the input query using the generative model that has been pretrained to perform internal reasoning prior to generating the query response to the input query, and performing a lookup in the AICP endpoint registry to identify the locally hosted application at the local AICP endpoint server that can perform a first task related to the first action and the remotely hosted application at the remote AICP endpoint server that can perform a second task related to the second action. In this aspect, additionally or alternatively, the local AICP endpoint server may be one of a plurality of local AICP endpoint servers, each having a respective locally hosted application. In this aspect, additionally or alternatively, the locally hosted applications may be one or more of a word processor, spreadsheet program, presentation program, email program, database program, coding editor, and/or drawing program. In this aspect, additionally or alternatively, the remote AICP endpoint server may be one of a plurality of remote AICP endpoint servers, each having a respective remotely hosted application. In this aspect, additionally or alternatively, the remotely hosted applications may be one or more of a generative language model, generative multimodal model, text-to-image generative model. In this aspect, additionally or alternatively, the memory may be configured to include short term memory, working memory, long term memory, and the AICP endpoint registry stored in the long term memory.

Another aspect provides a computing system for managing specialized tasks and information retrieval processes through service discovery, the system comprising processing circuitry and associated memory configured to implement a generative model system including an interaction interface, an orchestrator, and a plurality of data sources, wherein the orchestrator is configured to receive a request including a message having natural language input from the interaction interface, parse the message to identify one or more actions, generate an data request including the one or more actions, broadcast the data request to each of the plurality of data sources, receive service information from one or more of the plurality of data sources in response to the data request, compile the message and the one or more actions into a contextual bundle, input the contextual bundle into a generative model to generate a plan, and make calls to a subset of the plurality of data sources to execute the identified actions in accordance with the plan generated by the generative model. In this aspect, additionally or alternatively, the generative model may be a response model, the contextual bundle may be inputted into a reasoning model to generate a chain-of-thought response, the chain-of-thought response may be inputted into the response model to generate the plan.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system with artificial intelligence (AI) protocol endpoint-enabled service discovery, registration, and task management, the system comprising:
processing circuitry and associated memory configured to implement a generative model system including:
an interaction interface configured to receive an input query including natural language; and
a generative model agent configured to:
query an Artificial Intelligence Context Protocol (AICP) endpoint registry to identify at least a locally hosted application at a local AICP endpoint server and a remotely hosted application at a remote AICP endpoint server, at least one of the locally hosted application and remotely hosted application being a generative model;
establish a first AI context protocol session with the local AICP endpoint server;
transmit a first context for the first AI context protocol session to the locally hosted application at the local AICP endpoint server, via the first AI context protocol session;
receive a local endpoint response from the locally hosted application, via the first AI context protocol session;
establish a second AI context protocol session with the remote AICP endpoint server;
transmit a second context for the second AI context protocol session to the remotely hosted application at the remote AICP endpoint server, via the second AI context protocol session;
receive a remote endpoint response from the remotely hosted application, via the second AI context protocol session;
provide the local endpoint response and the remote endpoint response to a generative language model to generate a query response; and
output the query response to the interaction interface.

2. The computing system of claim 1, wherein the AICP endpoint registry includes respective IP addresses, capabilities, and text descriptions of each of the locally hosted application and the remotely hosted application.

3. The computing system of claim 2, further comprising:
an AICP endpoint discovery module configured to interrogate the local AICP endpoint server and the remote AICP endpoint server to thereby obtain the respective IP addresses, capabilities, and text descriptions of each of the locally hosted application and the remotely hosted application.

4. The computing system of claim 2, wherein the generative model agent is further configured to, prior to querying the AICP endpoint registry:
receive the input query from the interaction interface;
formulate a plan including at least a first action and a second action to respond to the input query using a generative model that has been pretrained to perform internal reasoning prior to generating the query response to the input query; and
perform a lookup in the AICP endpoint registry to identify the locally hosted application at the local AICP endpoint server that can perform a first task related to the first action and the remotely hosted application at the remote AICP endpoint server that can perform a second task related to the second action.

5. The computing system of claim 1, wherein the local AICP endpoint server is one of a plurality of local AICP endpoint servers, each having a respective locally hosted application.

6. The computing system of claim 5, wherein the locally hosted applications are one or more of a word processor, spreadsheet program, presentation program, email program, database program, coding editor, and/or drawing program.

7. The computing system of claim 1, wherein the remote AICP endpoint server is one of a plurality of remote AICP endpoint servers, each having a respective remotely hosted application.

8. The computing system of claim 1, wherein the remotely hosted applications are one or more of a generative language model, generative multimodal model, text-to-image generative model.

9. The computing system of claim 1, wherein the memory is configured to include short term memory, working memory, long term memory, and the AICP endpoint registry stored in the long term memory.

10. A generative model computerized method with artificial intelligence (AI) protocol endpoint-enabled service discovery, registration, and task management, the method comprising:
receiving an input query including natural language at an interaction interface;
querying an Artificial Intelligence Context Protocol (AICP) endpoint registry to identify at least a locally hosted application at a local AICP endpoint server and a remotely hosted application at a remote AICP endpoint server, at least one of the locally hosted application and remotely hosted application being a generative model;
establishing a first AI context protocol session with the local AICP endpoint server;
transmitting a first context for the first AI context protocol session to the locally hosted application at the local AICP endpoint server, via the first AI context protocol session;
receiving a local endpoint response from the locally hosted application, via the first AI context protocol session;
establishing a second AI context protocol session with the remote AICP endpoint server;
transmitting a second context for the second AI context protocol session to the remotely hosted application at the remote AICP endpoint server, via the second AI context protocol session;
receiving a remote endpoint response from the remotely hosted application, via the second AI context protocol session;
providing the local endpoint response and the remote endpoint response to a generative language model to generate a query response; and
outputting the query response to the interaction interface.

11. The computerized method of claim 10, wherein the AICP endpoint registry includes respective IP addresses, capabilities, and text descriptions of each of the locally hosted application and the remotely hosted application.

12. The computerized method of claim 11, further comprising:
interrogating the local AICP endpoint server and the remote AICP endpoint server to thereby obtain the respective IP addresses, capabilities, and text descriptions of each of the locally hosted application and the remotely hosted application.

13. The computerized method of claim 11, further comprising, prior to querying the AICP endpoint registry:
receiving the input query from the interaction interface;
formulating a plan including at least a first action and a second action to respond to the input query using a generative model that has been pretrained to perform internal reasoning prior to generating the query response to the input query; and
performing a lookup in the AICP endpoint registry to identify the locally hosted application at the local AICP endpoint server that can perform a first task related to the first action and the remotely hosted application at the remote AICP endpoint server that can perform a second task related to the second action.

14. The computerized method of claim 10, wherein the local AICP endpoint server is one of a plurality of local AICP endpoint servers, each having a respective locally hosted application.

15. The computerized method of claim 14, wherein the locally hosted applications are one or more of a word processor, spreadsheet program, presentation program, email program, database program, coding editor, and/or drawing program.

16. The computerized method of claim 10, wherein the remote AICP endpoint server is one of a plurality of remote AICP endpoint servers, each having a respective remotely hosted application.

17. The computerized method of claim 10, wherein the remotely hosted applications are one or more of a generative language model, generative multimodal model, text-to-image generative model.

18. The computerized method of claim 10, wherein the memory is configured to include short term memory, working memory, long term memory, and the AICP endpoint registry stored in the long term memory.

19. A computing system for managing specialized tasks and information retrieval processes through service discovery, the system comprising:
processing circuitry and associated memory configured to implement a generative model system including:
an interaction interface;
an orchestrator; and
a plurality of data sources, wherein
the orchestrator is configured to:
receive a request including a message having natural language input from the interaction interface;
parse the message to identify one or more actions;
generate an data request including the one or more actions;
broadcast the data request to each of the plurality of data sources;
receive service information from one or more of the plurality of data sources in response to the data request;
compile the message and the one or more actions into a contextual bundle;
input the contextual bundle into a generative model to generate a plan; and
make calls to a subset of the plurality of data sources to execute the identified actions in accordance with the plan generated by the generative model.

20. The computing system of claim 19, wherein
the generative model is a response model;
the contextual bundle is inputted into a reasoning model to generate a chain-of-thought response; and
the chain-of-thought response is inputted into the response model to generate the plan.
